(19) United States
(12) Patent Application Publication
(10) Pub. No.: US 2006/0267972 A1
(43) Pub. Date: Nov. 30, 2006

(54) POWER SAVING METHOD FOR THIN FILM TRANSISTOR LIQUID CRYSTAL DISPLAY

(76) Inventor: Chien-Yu Yi, Taoyuan (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/164,748

(22) Filed: Dec. 5, 2005

(30) Foreign Application Priority Data
May 26, 2005 (TW) 94117187

(51) Int. Cl. G09G 5/00

(52) U.S. Cl. 345/211

(57) ABSTRACT

A power saving method for a thin film transistor liquid crystal display is provided. The method is suitable for a thin film transistor liquid crystal display (TFT LCD). During image display period, different refresh frame rate are used accordingly to the different variation rates of the image frame data.

### CROSS-REFERENCE TO RELATED APPLICATION

This application claims the priority benefit of Taiwan application serial no. 94117187, filed on May 26, 2005. All disclosure of the Taiwan application is incorporated herein by reference.

### BACKGROUND OF THE INVENTION

1. Field of Invention

The present invention relates to a power saving method for a liquid crystal display. In particular, it relates to a power saving method for thin film transistor liquid crystal display.

2. Description of Related Art

Liquid crystal display, because of its lighter, thinner, power saving, non-radiation, and lower electromagnetic interference advantages, is widely used in cellular phones, notebook, personal digital assistants (PDAs), digital camera, digital video and other electronic products. Aggressive research and development efforts in the industry continuously improve the quality for the liquid crystal display.

FIG. 1 shows a circuit block diagram of a conventional liquid crystal display panel. With reference to FIG. 1, the circuit includes a timing controller 102, a gate driver 104, a source driver 106, and a liquid crystal panel 108. The liquid crystal panel 108 further includes a plurality of gate lines 110 for transmitting scanning signal, and source lines 112 for transmitting image signal, and a pixel array comprising a region encircled by the gate lines 110 and the source lines 112. In addition, the pixel array includes a plurality of thin film transistors 114 for driving the liquid crystal according to the scan signal and the transmission image signal.

As shown in FIG. 1, the thin film transistor liquid crystal display is a hold-type display. Under general operation condition of personal computer, notebook PC, cellular phone, and personal digital assistant (PDA) most of the image data in the form of static image or slow-moving text (for example, Windows® operating system); therefore, continuous refreshing image is not required for static image. If liquid crystal display refresh rate is about 60 frames per second (or 75 frames per second) for static image data, and such high refresh frame rates could induce higher power consumption.

### SUMMARY OF THE INVENTION

The objective of the present invention is for providing a power saving method for a thin film transistor liquid crystal display, for reducing the power consumption of a thin film transistor liquid crystal display.

The present invention provides a power saving method for a thin film transistor liquid crystal display using, during image display period, two different refresh frame rates for refreshing images in accordance to the variation rate of the image frame data

The present invention adopts the method of changing refresh frame rate of the liquid crystal display, to reduce the power consumption of the timing controller, gate driver, source driver and other integrated circuit, thus achieving the purpose of saving power consumption.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 schematically illustrates a circuit of a conventional thin film transistor liquid crystal display panel.

FIG. 2 is a circuit block diagram schematically illustrating a power saving method for a thin film transistor liquid crystal display according to an embodiment of the present invention.

FIG. 3 schematically illustrates an experimental data of a gate voltage of an amorphous thin film transistor.

FIG. 4 schematically illustrates an experimental data of a gate voltage of an amorphous thin film transistor with and without illumination.

FIG. 5 schematically illustrates an experimental data of a gate voltage of a low-temperature polysilicon thin film transistor with and without illumination.

FIG. 6 is a flow chart schematically illustrating the power saving method for the thin film transistor liquid crystal display according to an embodiment of the present invention.

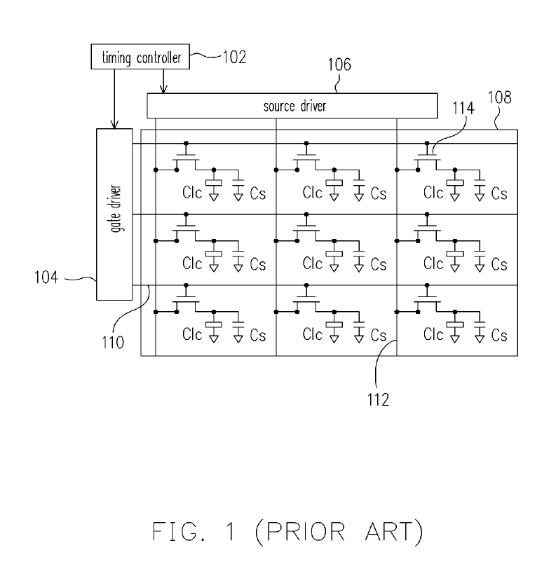

### DESCRIPTION OF THE EMBODIMENTS

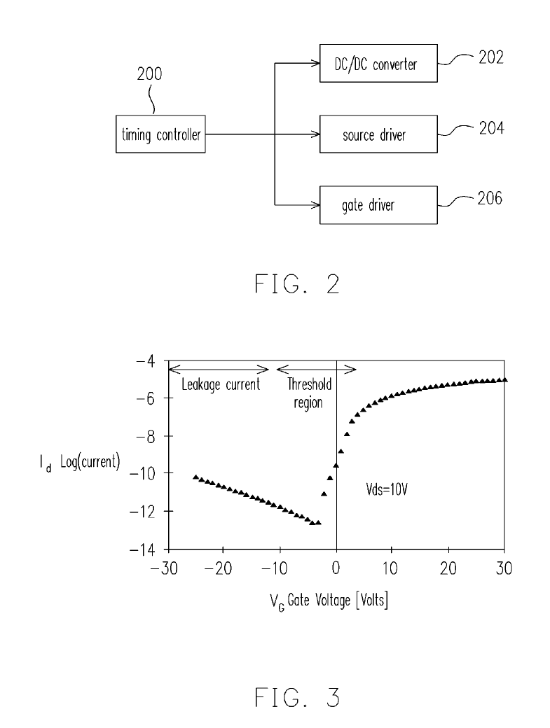

FIG. 2 is a circuit block diagram schematically illustrating a power saving method for a thin film transistor liquid crystal display according to an embodiment of the present invention. Referring to FIG. 2, the circuit includes a timing controller 200, a DC/DC converter 202, a source driver 204, and a gate driver 206. The timing controller 200 is mainly used for receiving an image data, and outputting a control signal to the DC/DC converter 202, source driver 204, and the gate driver 206 according to the image data. The gate driver 206 receives the control signal from the timing controller 200 to scan panel. The source driver 204 receives a display data from the timing controller 200, and DC/DC converter 202 can also be controlled by the timing controller 200 to switch to a sleep mode without DC voltage output for source driver 204 and gate driver 206 usage. During a normal operation mode, the liquid crystal display refreshes at 60 frames per second. At this time, the timing controller 200 has to be operated at a higher frame rate. Similarly, the source driver 204 and the gate driver 206 also have to operate at the higher frame rate. However, the higher frame rate causes more dynamic power consumption.

The timing controller 200 transmits a low-power consumption control signal to each block circuit to decides whether to enter the low-power consumption operating mode or not. The control signal may be not only a singular signal but also combined existing integrated circuit control signals to control the source driver/gate driver. Under the low-power consumption operation mode, all of the image data refresh frame rate, for example, refreshing 5 image data frames per second, is reduced. Because of the reduced image refresh data frame rate, the operating frequency of the timing controller 200, the source driver 204 and the gate driver 206 should be reduced. Because the thin film transistor liquid crystal display is a hold-type display, it does not require a high refresh frame rate for static image data. In addition, because of the reduced frame rate, the dynamic power consumption will be reduced, which is estimated more than 50% of power consumption in an embodiment of the present invention.

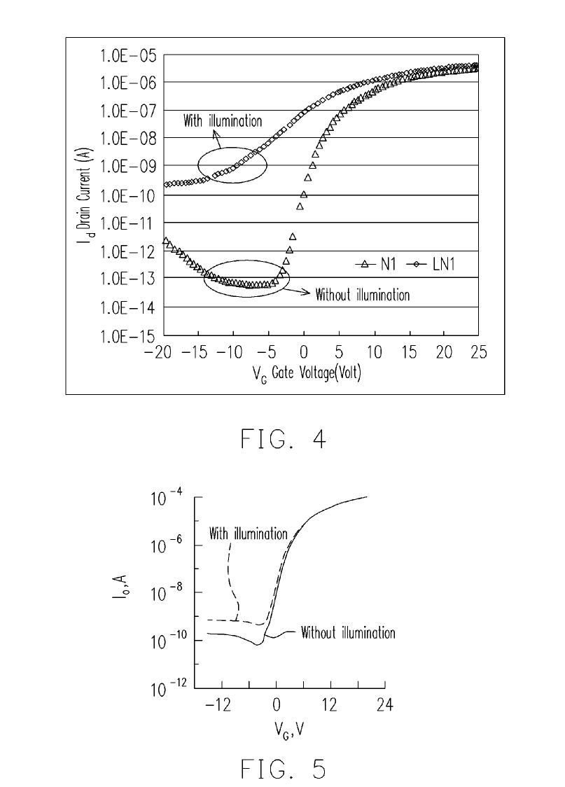

FIG. 3 shows an experimental data for drain current output with different gate voltage of an amorphous thin film transistor (Amorphous-TFT). As seen from FIG. 3, the leakage current of the Amorphous-TFT is very small during Amorphous-TFT turns off region. FIG. 4 shows an experiment data for drain current output with different gate voltage of an amorphous thin film transistor (Amorphous-TFT) during illumination. FIG. 4 shows that the leakage current of the Amorphous-TFT will be increased around ten thousand times with illumination by back light unit. But the scan frequency still can be modified according to the experimental visual results. For example, by reducing the image data frame rate from 60 frames per second to 10 frames per second. If this application method used in cellular phone or digital camera, because the backlight source of the backlight unit uses light emitting diode (LED) which has much lower brightness than the cold-cathode fluorescent lamp (CCFL) and displaying images mostly are static image date, the power consumption of the Amorphous-TFT display panel could be greatly reduced. And FIG. 5 shows an experimental data for drain current output with different gate voltage of a low-temperature polysilicon thin film transistor (LTPS-TFT) during illumination. By FIG. 5, it can be seen that the current leakage of the low-temperature polysilicon thin film transistor (LTPS-TFT) has a lower illumination sensitivity than Amorphous-TFT. By using the panel of the low-temperature polysilicon thin film transistor according to the method for the present invention, the power consumption of the LTPS-TFT display panel can be greatly reduced.

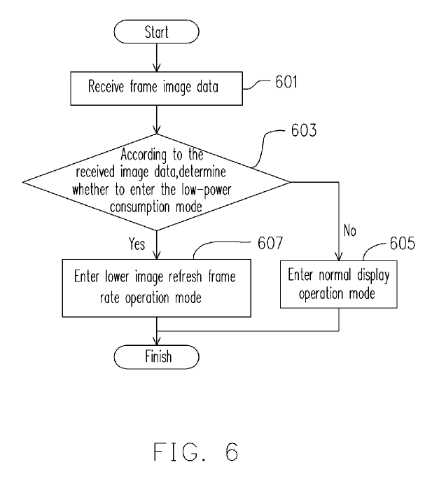

FIG. 6 is a flow chart of the power saving method for the thin film transistor liquid crystal display in the present invention. Referring to FIG. 6, firstly a frame image data is received (step 601). According to the received frame image data, it is determined whether to enter the low-power consumption mode (step 603). If it is determined not to enter the above mode, a normal display operation mode (step 605) will be selected instead. If it is determined to enter the above low power consumption mode, the lower image refresh frame rate will be used for refreshing the image (step 607).

Based on the above description, the present invention adopts a method of changing the refresh data frame rate of the LCD. Due to the reduced refresh data frame rate, the operating frequency for the timing controller, the gate driver, the source driver, and other integrated circuits can be lowered to achieve the purpose of saving power.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A power saving method for a thin film transistor liquid crystal display, comprising:
refreshing an image during an image display period using first refresh frequency and second refresh frequency according to the variation rate of the image frame data.

2. A power saving method for a thin film transistor liquid crystal display, comprising:
determining whether to enter a low-power consumption mode; and
refreshing the image with lower refresh frame rate during an image display period after entering the reduced power consumption mode.

3. The power saving method for the thin film transistor liquid crystal display according to claim 2, wherein the determination of whether to enter the low-power consumption mode comprises:
receiving the image frame data; and determining whether to enter the low-power consumption mode according to the image frame data.
